(19) United States
(12) Patent Application Publication
(10) Pub. No.: US 2013/0157264 A1
(43) Pub. Date: Jun. 20, 2013

(54) NUCLEIC ACID ANALYSIS DEVICE, NUCLEIC ACID ANALYSIS APPARATUS, AND NUCLEIC ACID ANALYSIS METHOD

(71) Applicants: Takayuki Obara, Tsuchiura (JP); Kazumichi Imai, Hitachinaka (JP); Toshiro Saito, Hitachinaka (JP); Satoshi Takahashi, Hitachinaka (JP)

(72) Inventors: Takayuki Obara, Tsuchiura (JP); Kazumichi Imai, Hitachinaka (JP); Toshiro Saito, Hitachinaka (JP); Satoshi Takahashi, Hitachinaka (JP)

(21) Appl. No.: 13/818,704

(22) PCT Filed: Jul. 19, 2011
(86) PCT No.: PCT/JP2011/004067

§ 371 Date: Feb. 25, 2013

(30) Foreign Application Priority Data
Sep. 10, 2010 (JP) 2010-202626

(51) Int. Cl. G01N 21/64

(52) U.S. Cl. CPC G01N 21/6486
USPC 435/6.1; 435/287.2

(57) ABSTRACT

In a nucleic acid analysis device which detects a fluorescent dye on a nucleic acid sample immobilized on a surface of a substrate by exciting the fluorescent dye with an evanescent wave, the detection of a fluorescence signal with a high SN ratio is realized even for a long nucleic acid sample.

The nucleic acid analysis device according to the invention is a nucleic acid analysis device in which a plurality of regions for immobilizing a nucleic acid sample are provided on a surface of a support base and a single molecule of a nucleic acid sample is immobilized on at least one of the regions, and which performs sequence determination by performing an extension reaction of the immobilized nucleic acid sample, wherein the immobilization of the single molecule of the nucleic acid sample on the support base is performed at two or more points.

### TECHNICAL FIELD

The present invention relates to a nucleic acid analysis device, a nucleic acid analysis apparatus, and a nucleic acid analysis method.

### BACKGROUND ART

There has been developed a new technique for determining the base sequences of nucleic acid samples including DNA and RNA as a nucleic acid analysis method.

Conventionally, in a method utilizing electrophoresis, which has been usually used, a cDNA fragment sample is prepared in advance by synthesis through a reverse transcription reaction of a DNA fragment or an RNA sample for sequence determination, a dideoxy reaction is performed by a well-known Sanger method, and then, electrophoresis is performed, and a pattern of separation and development of molecular weight is measured and analyzed.

In recent years, a method in which a lot of DNA fragments to be used as samples are immobilized on a substrate and the sequence information of the lot of fragments is determined in parallel (a parallel analysis method) has been realized. By using this method, sequences can be processed in parallel on an unprecedented large scale compared to a conventional method utilizing electrophoresis, and therefore, the method contributes to the improvement of the processing speed of the DNA sequence determination. Among the parallel analysis methods, a method in which sequence determination is performed for a single molecule as such without amplifying a DNA fragment of a sample (a single molecule sequencing method) has been proposed.

In Patent Literature 1, as a single molecule sequencing method, an example of a real-time sequence determination method is disclosed. In this Patent Literature 1, the following (1) to (3) are disclosed.

(1) Adhesive pads are formed regularly in a lattice pattern on a flat and smooth substrate. Each of the adhesive pads is bound to a microparticle through a chemical bond via a linear molecule. A functional group at an end of the linear molecule is bound to the adhesive pad through a chemical interaction.

(2) As a probe molecule for capturing a nucleic acid, a single-stranded nucleic acid molecule such as DNA or RNA can be used. An end of a nucleic acid molecule is previously modified in the same manner as a functional group and is allowed to react with a microparticle in advance. In order to immobilize a single molecule of a probe molecule on one microparticle, it is preferred that the particle diameter of the microparticle is as small as possible. A single microparticle can be immobilized on a single adhesive pad if a condition that the diameter d of the adhesive pad is smaller than the diameter D of the microparticle is satisfied.

(3) By using a probe molecule, a molecule of a nucleic acid sample having a specific complementary sequence can be captured. After the capture, by supplying a nucleic acid synthetase and nucleotides, a nucleic acid extension reaction can also be caused on the substrate. Nucleotides having a fluorescent dye are supplied and a nucleic acid synthetase is supplied. A nucleic acid extension reaction is caused on a device, and the fluorescence of the fluorescent dye incorporated in a nucleic acid chain during the extension reaction is measured. Four types of nucleotides each having a different fluorescent dye are supplied and a continuous nucleic acid extension reaction is caused without performing washing, followed by continuous observation of fluorescence. In this manner, a so-called real-time reaction method can also be realized. In this case, if a nucleotide having a fluorescent dye at a phosphate moiety is used, the phosphate moiety is cleaved after the extension reaction, and thus fluorescence can be continuously measured without quenching to obtain the information of the base sequence of the nucleic acid sample.

As described above, a method in which the sequence information of a lot of fragments is determined in parallel by immobilizing a lot of nucleic acid samples on a flat and smooth substrate has been developed and is being used in practice.

### CITATION LIST

### Patent Literature

Patent Literature 1: JP-A-2010-172271

### SUMMARY OF INVENTION

### Technical Problem

The inventors of this application made intensive studies of the length (fragment length) of a nucleic acid sample whose sequence can be determined by a single molecule sequencing method of a parallel analysis method, and as a result, they obtained the finding described below.

Among the single molecule sequencing methods of the parallel analysis methods, a method in which a DNA fragment is immobilized on a substrate as disclosed in Patent Literature 1 requires measuring weak fluorescence emitted by one fluorescent dye molecule. Therefore, in order to decrease the background light signal as much as possible, such a method employs a system capable of performing local illumination by an evanescent wave or the like as an excitation light irradiation system. By using an evanescent wave, a narrow area of from 100 to 200 nm on a surface of the flat and smooth substrate can be locally irradiated with excitation light, and therefore, a background light signal derived from surrounding substances can be suppressed. However, since the sample DNA fragment is immobilized on the substrate via one end thereof, the other moiety including the other end can move freely. Therefore, if the length of the sample DNA fragment is increased, a part of the DNA fragment may come out of the area irradiated with the evanescent wave. In such a case, excitation light for bases with a fluorescent dye incorporated in such a part becomes weak, and the SN ratio for the measurement of fluorescence emitted is decreased. Therefore, the method has a problem that the length of the DNA fragment whose sequence can be determined cannot be increased.

An object of the invention relates to a device for determining a base sequence with which the sequence determination of a longer nucleic acid sample can be realized.

### Solution to Problem

The nucleic acid analysis device according to the invention is a nucleic acid analysis device in which a plurality of regions for immobilizing a nucleic acid sample are provided on a surface of a support base and a single molecule of a nucleic acid sample is immobilized on at least one of the regions, and which performs sequence determination by performing an extension reaction of the immobilized nucleic acid sample, wherein the immobilization of the single molecule of the nucleic acid sample on the support base is performed at two or more points.

### Advantageous Effect of Invention

According to the invention, a distance between a nucleic acid sample and a surface of a support base can be decreased, and therefore, the nucleic acid sample can be retained within a local illumination area in the vicinity of the support base. Accordingly, it becomes possible to always excite bases with a fluorescent dye incorporated by a nucleic acid synthetase with sufficient intensity. As a result, it becomes possible to determine the base sequence of a longer nucleic acid sample.

### BRIEF DESCRIPTION OF DRAWINGS

FIG. 1 is a view for illustrating one example of a structure of a nucleic acid analysis apparatus.

FIG. 2 is a view for illustrating one example of a nucleic acid analysis method using a nucleic acid analysis device.

FIG. 3 is a view for illustrating one example of a nucleic acid analysis method using a nucleic acid analysis device.

FIG. 4 is a view for illustrating one example of a structure of a nucleic acid analysis device.

### DESCRIPTION OF EMBODIMENTS

Hereinafter, the above and other novel features and effects of the invention will be described with reference to the drawings. Here, in order to help complete understanding of the invention, specific embodiments will be described in detail, however, the invention is not limited to the contents described herein.

Further, as the drawings shown below, in order to facilitate the understanding, schematic drawings are used, and thus the dimensions and the like are sometimes different from the actual ones.

### Embodiment 1

A device and a method in which molecules of sample DNA fragments to be analyzed are captured one by one on a surface of a substrate at equal intervals, and then are extended by substantially one base at a time, and incorporated fluorescent labels are detected by one molecule at a time, whereby a base sequence is determined will be described. Specifically, the base sequence of a sample DNA is determined by repeating a cycle including a step of performing a DNA polymerase reaction using four types of dNTP derivatives, each of which has a detectable label and is incorporated in a DNA template as a substrate for a DNA polymerase so as to terminate a DNA extension reaction with the presence of a protecting group, subsequently, a step of detecting the incorporated dNTP derivatives by detecting the fluorescence or the like, and a step of returning the dNTP derivatives to a state of being extendable.

It is necessary to measure weak fluorescence emitted by one fluorescent dye molecule. Therefore, in order to decrease the background light signal as much as possible, such a method employs a system capable of performing local illumination by an evanescent wave or the like as an excitation light irradiation system. By using an evanescent wave, a narrow area of from 100 to 200 nm on a surface of the flat and smooth substrate can be locally irradiated with excitation light, and therefore, the background light signal derived from surrounding substances can be suppressed. It is preferred that this procedure is performed in an environment like a clean room via an HEPA filter or the like since the detection of single molecule fluorescence is performed by this procedure.

The “DNA” as used herein in “DNA fragment” or “sample DNA” is a representative of nucleic acid including DNA, RNA, PNA (peptide nucleic acids) and derivatives thereof and is not limited only to DNA. Similarly, as the base or base with fluorescence, dNTP or a dNTP derivative is used, however, even if NTP, an NTP derivative, or the like is used, the same effect can be obtained.

(Structure of Apparatus)

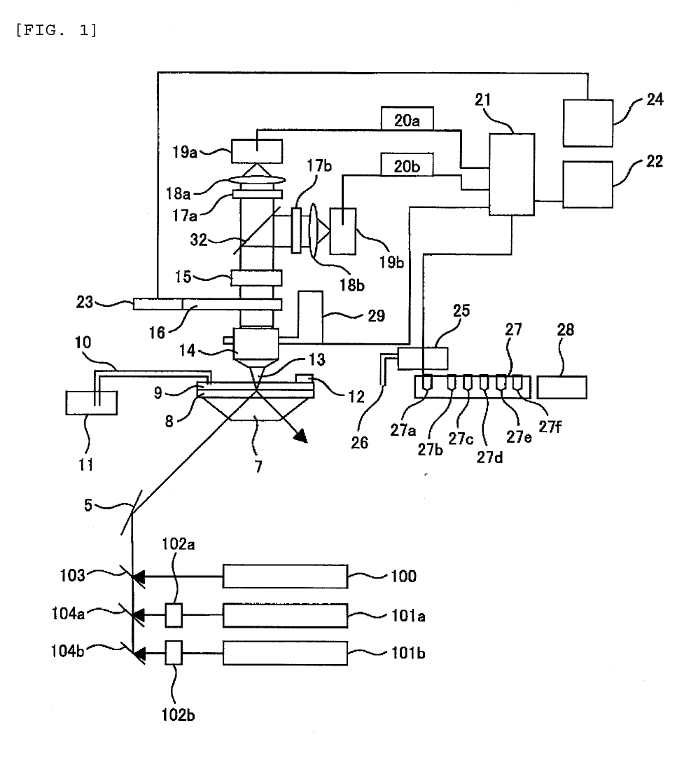

FIG. 1 is a structural view of a nucleic acid analysis apparatus using the nucleic acid analysis device of the invention. The apparatus has a structure similar to that of a microscope and performs the measurement of an extension reaction of a sample DNA captured on a substrate 8 by detection of fluorescence.

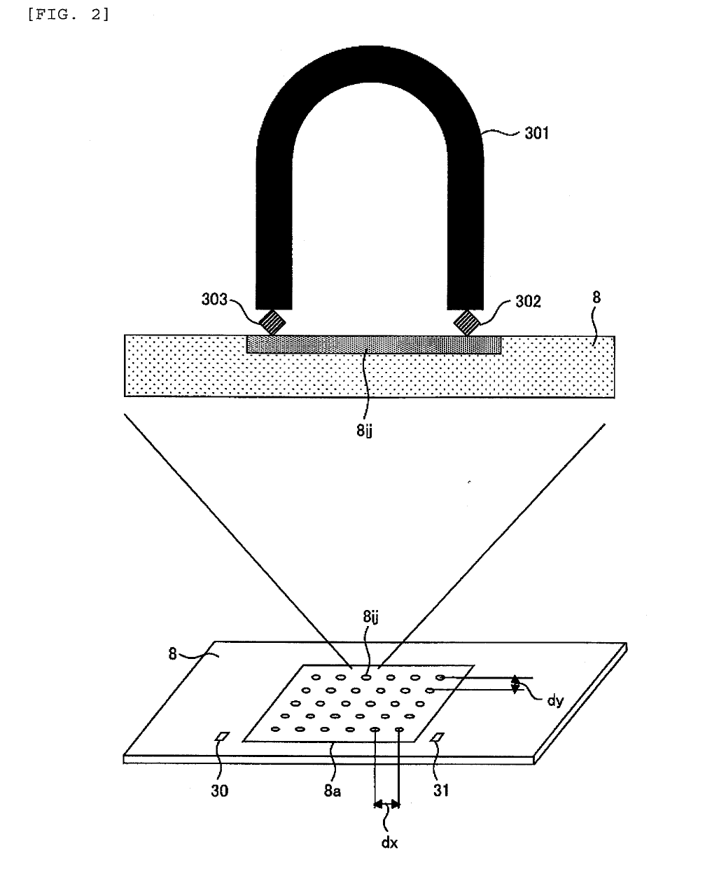

The nucleic acid analysis device has a structure shown in FIG. 2. The substrate 8 is at least in part made of a transparent material. As the material, synthetic quartz or the like can be used. The substrate 8 has a reaction region 8a, which is made of a transparent material and is brought into contact with a reagent and the like necessary for a DNA extension reaction.

In the reaction region 8a, one or more regions 8ij on which DNA is immobilized are formed. Each region 8ij preferably has a diameter of 100 nm or less. This region is subjected to a surface treatment for capturing DNA at 2 or more points therein. By selecting an appropriate combination of the surface treatment and a modification 303 of a DNA fragment to be captured, the DNA fragment can be captured in the region 8ij. Further, when a DNA fragment is immobilized, by appropriately controlling the concentration of the DNA fragment, only a single DNA molecule can be placed in each region 8ij. Further, by decreasing the size of the region 8ij, the number of molecules which can be captured in the region can be set to one.

Then, the substrate in such a state is measured. In such a substrate, there is a case where a single DNA molecule is captured in every region 8ij, and there is a case where DNA is captured only in a part of the regions 8ij. In the case where DNA is captured only in a part of the regions 8ij, DNA is not captured in the remaining regions 8ij, which are vacant. The regions 8ij form a lattice structure (a two-dimensional lattice structure) in this manner, and the regions 8ij are located at the positions of the lattice points.

In the surface treatment of the regions 8ij, a protein which shows a specific interaction, a reactive functional group, a nucleic acid molecule, a metal, or the like can be used. More specifically, as the protein which shows a specific interaction, a biotin-binding protein such as avidin, streptavidin, or neutravidin; a DNA-binding protein such as an antibody or a single-strand-binding protein; or the like may be used. As the reactive functional group, a thiol group, an amino group, a carboxyl group, a phosphate group, an aldehyde group, or the like can be used. As the nucleic acid, DNA, RNA, or a derivative thereof, or other than these, PNA (a peptide nucleic acid) may be used. Further, as the metal, gold, silver, aluminum, chromium, titanium, tungsten, platinum, or nickel may be used.

As the form of the surface treatment, the bonding to the substrate may be achieved by a covalent bond. By using a covalent bond, the nucleic acid sample can be firmly immobilized so as to avoid dissociation of the nucleic acid sample during the analysis process, and therefore the use of a covalent bond is preferred. Further, the immobilization on the substrate may be achieved by chemical or physical adsorption. Further, the surface of the substrate may be directly modified. For example, in the case where synthetic quartz is used as the substrate, by performing a treatment with aminosilane, a surface treatment with an amino group can be introduced, and also BSA-biotin, in which biotin is introduced into BSA (bovine serum albumin) having a property of being adsorbed on quartz, may be adsorbed on the surface of quartz. Further by combining both, it is also possible to immobilize a biotinylated DNA-binding protein on BSA-biotin adsorbed on the surface of quartz through avidin.

As the modification 303 of a DNA fragment 301 to be captured, biotin, an antigen, a thiol group, an amino group, a carboxyl group, a phosphate group, an aldehyde group, a microparticle of a metal such as gold, or the like can be used.

Further, in the case where a nucleic acid molecule or a DNA-binding protein is used as the surface treatment of the regions 8ij, the capturing of the DNA fragment can be achieved directly by hybridization, and therefore, the nucleic acid molecule or a DNA sequence itself, to which the DNA-binding protein binds functions as the modification 303. For example, as the surface treatment, a nucleic acid molecule having a poly(T) sequence is immobilized on the regions 8ij as a probe DNA in advance, a DNA fragment in which a poly(A) sequence is added to one end thereof or a mRNA molecule which originally has a poly(A) sequence in the vicinity of the 3′ end can be captured. In this manner, a sequence which is newly added to the sample DNA or a sequence which the sample DNA originally has can be used as the modification 303.

Further, for example, in the case where a DNA-binding protein having low selectivity for a DNA sequence to which the protein is to bind such as histone is used as the surface treatment, the entire DNA fragment 301 functions as the modification 303.

The position of the modification 303 in the DNA fragment 301 to be captured is not particularly limited, but is preferably at the 5′ end, the 3′ end, or in the vicinity thereof. By capturing the DNA fragment at such a position, a region in which the sequence of the DNA fragment can be determined can be made large.

By introducing two modifications 303 and 302 at two or more positions in one DNA fragment 301 to be captured, the DNA fragment can be captured on the substrate at two or more points. For example, by biotinylating the DNA fragment at the 5′ end and the 3′ end, and binding streptavidin in the regions 8ij in advance, the DNA fragment can be captured on the substrate at the two points, i.e. , at the 5′ end and the 3′ end. By doing this, as compared with the case where the capturing is performed at one point, the DNA fragment, particularly a moiety of the fragment farthest from the point where the DNA fragment is captured is located in a space closer to the surface of the substrate 8.

In general, in the case where a sample DNA fragment is captured on a substrate at one end thereof, the other moiety including the other end can move freely. Therefore, if the length of the sample DNA fragment is increased, a part of the DNA fragment may sometimes come out of an area irradiated with an evanescent wave. In such a case, excitation light for bases with a fluorescent dye incorporated in such a part becomes weak, and the SN ratio for the measurement of fluorescence emitted is decreased. However, by capturing a DNA fragment on a substrate at two points as described above, a part of the DNA fragment which is measured for fluorescence can be prevented from coming out of an area irradiated with an evanescent wave.

In this manner, a decrease in the SN ratio when the length of the DNA fragment is increased can be prevented. Accordingly, it becomes possible to perform the sequence determination of a longer DNA fragment.

In the case where the surface treatment of the regions 8ij to be used for the immobilization of the DNA fragment 301 is such that a nucleic acid molecule which hybridizes to the DNA fragment 301 is immobilized and the molecule functions as a primer for a DNA extension reaction, since the extension reaction proceeds in the direction from the 5′ end to the 3′ end, it is preferred that the nucleic acid molecule is immobilized on the substrate at the 5′ end. Alternatively, it is necessary that at least the 3′ end of the nucleic acid molecule be free.

Further, by capturing the DNA fragment 301 at three or more points, an effect on the retention of the DNA fragment on the surface of the substrate can be further enhanced. This can be achieved by, for example, using a sequence which appears a plurality of times in a long DNA fragment such as a repetitive sequence in a genome as the modification 303, and performing a surface treatment with a DNA fragment having a sequence complementary thereto in advance. In this manner, it becomes possible to perform capturing at three or more points. Further, also in the case where a single-strand-binding protein is used as the surface treatment and the entire DNA fragment is used as the target for capturing, the same effect can be obtained.

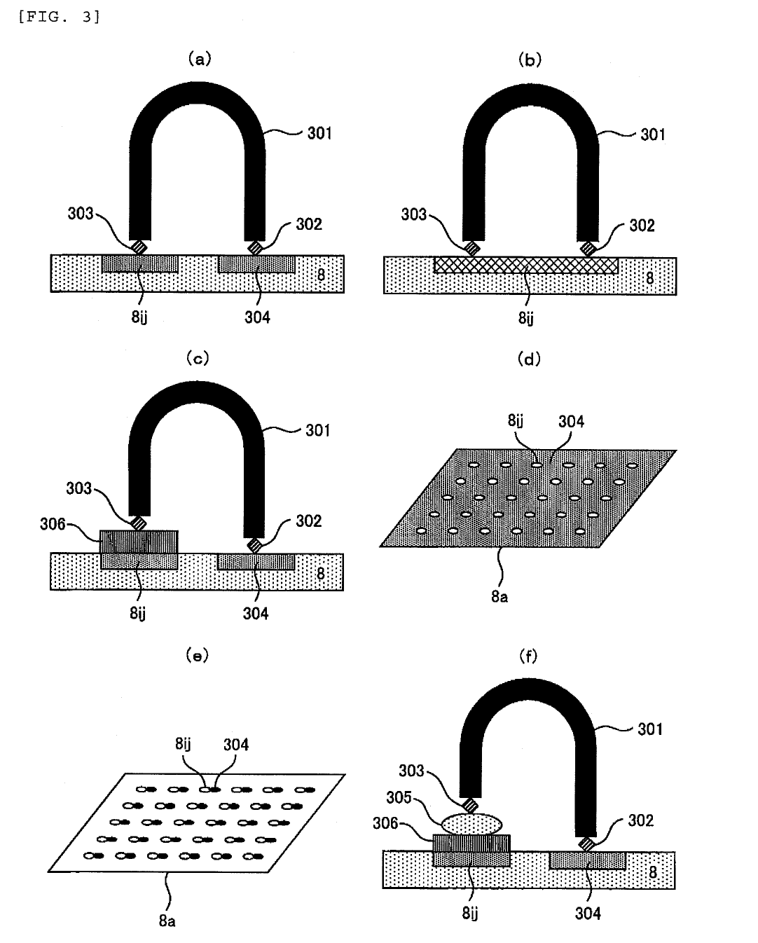

Further, as shown in FIG. 3(a), a region 304 having been subjected to a different surface treatment so that the second or thereafter modification 302 can be captured may be provided as a separate region adjacent to or apart from the region 8ij. Further, such a region 304 may be provided on the entire reaction region 8a excluding the regions 8ij as shown in FIG. 3(d), or may be provided in parts of the reaction region 8a excluding the regions 8ij as shown in FIG. 3(e). In this case, the distance between the positions of the two points where the modifications 303 and 302 are captured can be increased while maintaining the area of the region 8ij small. By decreasing the area of the region 8ij, the probability that only one molecule of the DNA fragment 301 is captured in the region 8ij can be increased. The distance between the region 304 and the region 8ij is not particularly limited, but is preferably smaller than the average length of the DNA fragment 301 to be captured or the dimensions of the distances dx and dy between the regions 8ij.

Further, as shown in FIG. 3(b), by allowing two different surface treatments to coexist in the region 8ij, both of the two types of modifications 302 and 303 of the DNA fragment 301 may be captured in the region 8ij. Such surface treatments can be realized by mixing and immobilizing two types of probe DNAs each having a different sequence.

As for a method for producing such a substrate having regions 8ij arranged at equal intervals, for example, a method described in JP-A-2002-214142 or the like is used to effect the production. Each of the distances dx and dy is larger than the size of each region 8ij, and is preferably from 0.2 to 10 μm or less, and more preferably about from 0.5 to 6 μm.

The region at the position of the lattice point (the spot or the region at the lattice point) preferably has a diameter of 100 nm or less, which is preferably equal to or less than one third of the distance between at least the adjacent closest lattice points. This structure permits easy optical resolution so as to achieve easy recognition. The lattice structure may be a square lattice structure, a rectangle lattice structure, a triangle lattice structure, etc. The size of the reaction region 8a of the substrate is set to 1 mm×1 mm. The reaction region 8a can be larger than the above size. Alternatively, the reaction regions, each having a size of 0.5 mm×0.5 mm, may be arranged side by side in one- or two-dimensional manner at certain intervals. The shape of the region may be a rectangle, a circle, a triangle, a hexagon, etc. In the following description, among these possibilities, a case where dx and dy are set to 2 μm will be described.

As shown in FIG. 3(c), an adhesive pad 306 may be disposed in the region 8ij. The adhesive pad 306 may be made of a material capable of providing the above-described surface modification, and for example, a metal structure can be used. It is also possible to produce the metal structure by a semiconductor process such as electron-beam lithography, optical lithography, dry etching, wet etching, etc. As the metal structure, a structure which is made of gold, silver, aluminum, chromium, titanium, tungsten, platinum, nickel, or the like, has a size equal to or less than the wavelength of excitation light, has a shape of a rectangular parallelepiped, a cone, a circular cylinder, or a triangular prism, or has a protruding portion, or a structure in which two or more of these structures are closely arranged side by side, or a metal microparticle, etc. can be used. For example, film-shaped gold dots each having a diameter of from about 10 nm to 100 nm can be constructed in a lattice pattern by setting the above-described intervals of dx and dy to, for example, 1×1, 1×2, 1×3, 2×3, 2×4, 3×5, 3×6 (μm×μm), etc.

In order to provide the region 304 having been subjected to a different surface treatment so that the second or thereafter modification 302 can be captured separately from the region 8ij, in the case where parts of the reaction region 8a excluding the regions 8ij are formed as the regions 304 as shown in FIG. 3(e), for example, the above-described semiconductor process is repeatedly performed twice, whereby such regions can be produced.

Further, in the case where the entire surface of the reaction region 8a excluding the regions 8ij is formed as the region 304, for example, synthetic quartz is used as the substrate 8, the gold adhesive pads 306 are disposed as the regions 8ij. Then, aminosilane is allowed to react with the quartz in the reaction region 8a to introduce an amino group, and thereafter biotin-succinimide (NHS-biotin, manufactured by Pierce Chemical Company) is allowed to react. In this manner, a substrate having gold as the surface treatment of the regions 8ij and biotin as the surface treatment of the entire surface of the reaction region 8a can be produced.

As shown in FIG. 3(f), a microparticle 305 having been subjected to a surface treatment may be immobilized on the region 8ij. Also in this case, the above-described adhesive pad 306 may be disposed in the region 8ij. As the microparticle, for example, a polystyrene bead having streptavidin immobilized on the surface thereof can be used. At this time, by setting the diameter of the adhesive pad 306 to a value equal to or smaller than the diameter of the microparticle, one molecule can be easily immobilized. For example, by capturing a protein, a fluorescent substance, or a linker having a size of about 20 nm on an upper part of the above-described dot having a diameter of about 20 nm, it is probably possible to capture one molecule per dot to arrange a single molecule in a lattice pattern on the basis of the size thereof. Further, by attaching a selective linker to the dot by a well-known method and allowing the linker to capture an oligonucleotide, a protein, or the like, a target molecule can be captured on the dot, and therefore this procedure can be used.

In the case where the metal structure is formed on the substrate 8, by detecting the photoluminescence or light scattering of the structure, the spatial position of the structure can be detected and can be utilized as a reference marker for the position, and therefore, the use of the metal structure is effective.

As the fluorescent label for the dNTP, various phosphors can be used. For example, four types of dNTPs, which are labeled respectively with different four types of phosphors using Bodipy-FL-510, R6G, ROX, and Bodipy-650 and whose 3′ ends are modified with an allyl group (3′-O-allyl-dGTP-PC-Bodipy-FL-510, 3′-O-allyl-dTTP-PC-R6G, 3′-O-allyl-dATP-PC-ROX, and 3′-O-allyl-dCTP-PC-Bodipy-650) are used. It is also possible to use dNTPs modified with phosphors other than these.

A laser beam from a laser light source 101a for excitation of fluorescence (Ar laser, 488 nm, for excitation of Bodipy-FL-510 and R6G) is passed through a λ/4 wave plate 102a and converted into circular polarized light. A laser beam from a laser light source 101b for excitation of fluorescence (a He—Ne laser, 594.1 nm, for excitation of ROX and Bodipy-650) is passed through a λ/4 wave plate 102b and converted into circular polarized light. Both laser beams are overlapped with each other via a mirror 104b and a dichroic mirror 104a (which reflects light having a wavelength of 520 nm or less). The overlapped light vertically enters an incidence plane of a prism 7 made of quartz for total reflection illumination via a mirror 5 as shown in the drawing, and is irradiated from the back side of the substrate 8 on which a DNA molecule is captured. The quartz prism 7 and the substrate 8 are in contact with each other via a matching oil (nonfluorescent glycerin or the like). The laser beam does not reflect at an interface between the prism and the substrate, and is guided into the substrate 8. The substrate 8 has a surface covered with a reaction solution (water). At an interface between the substrate surface and the solution, the laser beam totally reflects to generate evanescent illumination. By the evanescent illumination, only an area in the immediate vicinity of the surface of the substrate 8 (at a distance of about a wavelength of excitation light) is illuminated, and its intensity exponentially decreases with respect to the distance from the substrate. Accordingly, the effect of the background light is suppressed, and thus, the measurement of fluorescence can be performed with a high S/N ratio.

In the vicinity of the substrate, a temperature adjustment device is disposed, but the illustration thereof is omitted in the drawing. For normal observation, the apparatus has a structure in which halogen illumination or LED illumination can be applied from the bottom of the prism, the illustration of which is omitted in the drawing.

Further, a laser device 100 (a YAG laser, 355 nm) other than the laser light sources 101a and 101b is disposed. A laser beam from the laser device 100 can be overlapped with the laser beams from the laser light sources 101a and 101b via a dichroic mirror 103 (which reflects light having a wavelength of 400 nm or less) to be applied on the same optical axis. This laser is used in the step of returning the dNTP derivative to a state of being extendable after detecting the fluorescence of the incorporated dNTP derivative.

On the upper part of the substrate 8, a flow chamber 9 in which a reagent or the like is allowed to flow to perform a reaction is provided. The flow chamber has an inlet 12, a dispensing unit 25 with a dispensing nozzle 26, a reagent storage unit 27, and a tip box 28, and is designed to dispense a desired reagent solution or the like. In the reagent storage unit 27, a sample solution container 27a, dNTP derivative solution containers 27b, 27c, 27d, and 27e (the containers 27c, 27d, and 27e are for backup), a washing liquid container 27f, and the like are provided. A dispensing tip in the tip box 28 is attached to the dispensing nozzle 26, which sucks an appropriate reagent solution, and then guides the reagent solution from the chamber inlet to the reaction regions of the substrate to perform a reaction. A waste liquid is discharged into a waste liquid container 11 via a waste liquid tube 10. These are automatically performed by a control PC 21.

The flow chamber is formed of a material which is transparent in the direction of the optical axis for performing detection of fluorescence. Fluorescence 13 is collected by a condenser lens (objective lens) 14 to be controlled by an automatic focusing device 29. The fluorescence having a necessary wavelength is taken out by a filter unit 15 and the fluorescence transmitted through the filter unit 15 which removes light having an unnecessary wavelength is separated into light fluxes divided at a different ratio for each wavelength by a dichroic mirror 32. The separated light fluxes are respectively passed through auxiliary filters 17a and 17b, and an image is formed and detected on CCD cameras 19a and 19b (high sensitivity cooling two-dimensional CCD cameras) by imaging lenses 18a and 18b. The control of setting of an exposure time of the camera, timing of capturing a fluorescent image, and the like is performed by the control PC 21 via two-dimensional sensor camera controllers 20a and 20b. The filter unit 15 uses two types of notch filters (for 488 nm and 594.1 nm) for removing a laser beam, and a bandpass interference filter (transmittance bandwidth: 510 to 700 nm) for transmitting fluorescence in a wavelength range to be detected therethrough in combination.

This apparatus is provided with a lens tube 16 for observation of transmitted light, a TV camera 23, and a monitor 24 for adjustment or the like, and thus the state of the substrate 8 can be observed in real time by halogen illumination or the like.

As shown in FIG. 2, positioning markers 30 and 31 are inscribed on the substrate 8. The positioning markers 30 and 31 are disposed in parallel to the line of the regions 8ij, and a distance between the marker and the region is defined. Therefore, by detecting the markers by observation with transmission illumination, the positions of the regions 8ij can be calculated.

A general two-dimensional sensor camera such as a CMOS camera may be used. In this embodiment, a CCD area sensor is used, however, a two-dimensional sensor camera can be used. A CCD area sensor in which the pixel size and the number of pixels vary can be used. For example, a cooling CCD camera, which has a pixel size of 7.4 μm×7.4 μm, and in which the number of pixels is 2048×2048 is used. As the two-dimensional sensor camera, an imaging camera such as a CMOS area sensor other than the CCD area sensor can be generally used. Further, in the CCD area sensor, there are a backside illumination type CCD area sensor and a front illumination type CCD area sensor, which are classified in terms of structure, and both types can be used. Further, an electron multiplication type CCD camera having a multiplication function of a signal inside an element or the like is effectively used in order to achieve high sensitivity. The sensor is preferably a cooling type, and can reduce the dark noise of the sensor to thereby enhance the accuracy of measurement by being cooled to about −20° C. or lower.

The fluorescent image from the reaction region 8a may be detected at one time, or can be divided into some parts. In this case, an X-Y moving mechanism for moving the position of the substrate is disposed at a lower part of a stage, whereby the control PC controls the moving to an irradiation position, the irradiation of light, and the detection of a fluorescent image. In this embodiment, the X-Y moving mechanism is not shown.

(Nucleic Acid Sample Capture Step)

First, a method for preparing a nucleic acid sample will be described. A genomic DNA is fragmented into fragments by a well-known method. An adaptor DNA is ligated to both ends of the fragments. As the adaptor DNA, one obtained by the hybridization of two oligo DNAs is used. The two oligo DNAs have a complementary sequence, and one is biotinylated at the 5′ end and the other is biotinylated at the 3′ end. The fragmented genomic DNA to which the adaptor DNA is ligated is thermally denatured and dissociated into single strands. By doing this, nucleic acid samples each composed of a single-stranded DNA biotinylated at both ends can be produced. In the same manner, one of two oligo DNAs is modified with thiol at the 3′ end and the other oligo DNA is modified with an amino group or the like at the 5′ end, whereby a nucleic acid sample having different modifications at both ends can be prepared.

In each of the regions 8ij of the nucleic acid analysis device, a metal structure into which biotin is introduced by the above-described method is disposed. A buffer solution containing streptavidin is introduced into the chamber through the inlet 12, then, streptavidin is bound to biotin captured in the metal structure, whereby a biotin-avidin complex is formed. By doing this, both ends of the nucleic acid sample can be immobilized on the substrate 8. A primer is hybridized to a biotin-modified single-stranded DNA template, which is the nucleic acid sample, and then, a buffer solution containing the above-prepared DNA template-primer complex and a large excess amount of biotin is introduced into the chamber, and the single molecule DNA template-primer complex is captured on the metal structure disposed at each lattice point via a biotin-avidin bond. After the capturing reaction, the excess DNA template-primer complex and biotin are washed away from the chamber with a washing buffer.

(Reaction Step)

A step of a stepwise extension reaction will be described below. The reaction step is performed with reference to Proc. Natl. Acad. Sci. USA, vol. 100, pp 3960, 2003 and Proc. Natl. Acad. Sci. USA, vol. 102, pp 5932, 2005.

Thermo Sequenase Reaction buffer obtained by adding Thermo Sequenase polymerase and four types of dNTPs, which are labeled respectively with different four types of phosphors and whose 3′ ends are modified with an allyl group (3′-O-allyl-dGTP-PC-Bodipy-FL-510, 3′-O-allyl-dTTP-PC-R6G, 3′- allyl-dATP-PC-ROX, 3′-O-allyl-dCTP-PC-Bodipy-650) is introduced into the chamber through the inlet 12 and an extension reaction is performed. The dNTP incorporated in the DNA template-primer complex is modified with an allyl group at the 3′ end, whereby one or more bases are not incorporated in the DNA template-primer complex. After the extension reaction, unreacted each type of dNTP and polymerase are washed away with a washing buffer. Then, a chip is irradiated with laser beams emitted from the respective light sources, the Ar laser light source 101a and the He—Ne laser light source 101b, at the same time. By the laser irradiation, the phosphor used for labeling the dNTP incorporated in the DNA template-primer complex is excited and fluorescence emitted therefrom is detected. The type of the base of the dNTP can be determined by determining the wavelength of the fluorescence from the phosphor used for labeling the dNTP incorporated in the DNA template-primer complex. Since evanescent illumination is used, only an area in the vicinity of the surface of the reaction region becomes an excitation light irradiation region, so that the phosphor present in a region other than the surface of the reaction region is not excited, and therefore, measurement can be performed with less background light. Although the washing is performed after the extension reaction in the above case, there are also some cases where the measurement can be performed without requiring washing when the concentration of the fluorescently labeled dNTP is low. That is, it becomes possible to determine base sequence in real time.

Then, a laser beam emitted from the YAG laser light source 100 is irradiated onto the chip to remove the phosphor used for labeling the dNTP incorporated in the complex by optical cutting. Then, a solution containing palladium is introduced into a flow path. The allyl group at the 3′ end of the dNTP incorporated in the complex is replaced with a hydroxyl group in a palladium catalytic reaction. By replacing the allyl group at the 3′ end with the hydroxyl group, the extension reaction of the DNA template-primer complex can be restarted. After the catalytic reaction, the chamber is washed with a washing buffer. By repeatedly performing the procedure, the sequence of the captured single-stranded DNA template is determined.

This system can simultaneously measure fluorescence from a plurality of the regions 8ij in the reaction region 8a. Therefore, in the case where different DNA templates are captured in the respective regions 8ij, the types of bases of the dNTPs incorporated in a plurality of the different DNA template-primer complexes, that is, the sequences of a plurality of the DNA templates can be simultaneously determined. In other words, it becomes possible to determine base sequences by a parallel analysis method.

(Detection of Fluorescence and Identification of Phosphor)

A method for measuring intensity by detecting fluorescence of the phosphor captured on the substrate and identifying the type of the phosphor, that is, the type of the base will be described.

In FIG. 1, the imaging magnification on the CCD cameras 19a and 19b is set to 14.8 times, and fluorescence is measured for a plurality of the regions 8ij (lattice points) in which DNA is to be captured. In this case, the distance of dx (=2 μm) is divided into four, and detected by CCD pixels. By using a dichroic mirror which divides light at a different ratio for each wavelength, the fluorescence intensity at one bright spot is divided, and the divided fluorescence intensities are detected by different pixels, whereby the four types of phosphors can be identified and fluorescence can be detected. The control PC 21 extracts fluorescence bright spots from the regions 8ij in the images on the respective CCD cameras, computes the fluorescence intensity ratios thereof, and determines fluorescence emitted from which phosphor the fluorescence bright spot corresponds to, whereby the type of the base can be identified and the sequence analysis can be achieved.

The phosphors which can be used is not limited to those shown in this Embodiment, and any combination of phosphors which have different fluorescent properties using given excitation light can be used in the same manner. In general, a combination of phosphors having different fluorescence maximum wavelengths may be used.

In this embodiment, as the dichroic mirror 32, a dichroic mirror whose transmittance is substantially linear from substantially 0% to substantially 100% in a specified wavelength range is used, however, a dichroic mirror whose transmittance is substantially linear from substantially 10% to substantially 80% may be used. Alternatively, a segmented mirror whose transmittance and reflectance are different for each fluorescence maximum wavelength of a plurality of phosphors to be used may be used. For example, it is also possible to use a mirror having characteristics which change in a stepwise manner for each fluorescence maximum wavelength. Any mirror can be used as long as the mirror has an ability to divide light at a different ratio for each fluorescence maximum wavelength or each wavelength exhibiting the maximum peak of a plurality of phosphors as targets.

Although background light exists in the measurement of fluorescence, in the above description, signal components from which background light components are excluded are described.

In addition, a laser beam enters an incidence plane of the prism 7 made of quartz vertically, that is, at an incident angle of 0 degrees. According to this configuration, even if the substrate 8 and the prism are moved integrally, the laser radiation position does not come out of the observation field of view of the objective lens. Accordingly, the substrate and the prism can be integrated with each other, and various methods of coupling the prism and the substrate can be selected. Optical bonding as well as oil coupling is possible, and the apparatus configuration can be easily selected.

In this embodiment, the number of fluorescent molecules bound to each region 8ij of the substrate 8 is one, and a plurality of different fluorescent molecules do not exist at the same place. Therefore, according to the apparatus and the method of the invention, the types of phosphors, that is, the types of bases can be efficiently identified, and moreover, the apparatus and the method can be applied to a high-density substrate.

According to this embodiment, a plurality of objects to be measured are precisely disposed, and images of the objects to be measured are respectively formed at given pixels of a plurality of detectors having a plurality of detection pixels, and the fluorescence intensity ratio is measured for each detector. In this manner, a larger number of types of phosphors can be identified, and the fluorescence intensities thereof can be computed. In particular, three types, or four or more types of phosphors as the labeling materials can be identified and detected by one or two two-dimensional CCD cameras as the detectors. This can suppress the apparatus cost and also enables the detection of a single molecule at a time.

In this embodiment, the wavelength range to be detected is from 500 to 700 nm, but is not limited thereto. The wavelength range to be detected can be arbitrarily set to a range of from 400 to 600 nm, from 400 to 700 nm, and so on. The wavelength range to be detected can be adjusted within a range of from around the fluorescence maximum wavelength of the type of phosphor having the shortest fluorescence maximum wavelength to around the fluorescence maximum wavelength of the type of phosphor having the longest fluorescence maximum wavelength among the types of phosphors to be used. It is not necessary to strictly adjust the wavelength range to be detected between the fluorescence maximum wavelengths. It is only necessary to be able to divide light at a different ratio around the fluorescence maximum wavelength of each type of phosphor. In addition, if the intensity ratio of fluorescence when receiving light from a given phosphor is different from that of other phosphor, a plurality of phosphors can be identified.

In this embodiment, light for the measurement of fluorescence is irradiated onto the substrate 8 on which a biologically relevant molecule such as an oligonucleotide is captured at two or more points per molecule, fluorescence generated therefrom is collected, an image of the collected fluorescence is formed on a two-dimensional sensor camera, and the fluorescence is detected by a two-dimensional detector. The substrate 8 is a substantially transparent substrate and has a plurality of regions 8ij, in which a molecule can be captured, and which are disposed at positions of lattice points in a lattice structure. A necessary reagent, a sample, and the like are allowed to react on the substrate, and phosphors on the substrate are excited by a light source for light excitation for total reflection illumination and a radiation optical system. Then, fluorescence generated therefrom is collected by a fluorescence collecting system. Light fluxes of the collected fluorescence are divided by a light dividing section at a ratio substantially different for each wavelength in a specified wavelength range. Then, images of the divided light fluxes are formed on a detector by an imaging optical system and detection is performed by the detector having a plurality of detection pixels. Further, a data processing section computes the intensities at bright spots corresponding to the divided fluorescent images, and determines the types of phosphors on the basis of the fluorescence intensity ratios. In this manner, various types of phosphors can be easily identified and detected.

Further, in this embodiment, an example in which the substrate having the capture regions 8ij arranged in a lattice pattern at certain intervals is used is shown. Such an arrangement of the regions 8ij in a lattice pattern facilitates the identification of corresponding bright spots between a transmission image and a reflection image. In the case where the capture positions are randomly dispersed, the corresponding bright spots may be determined by comparing two images with each other for pattern analysis or referring to reference markers. The same effect can be obtained also in this manner.

### Embodiment 2

Another embodiment of the reaction substrate will be described. In this embodiment, a method for suppressing background light using near-field light generated in a minute opening in place of an evanescent wave will be shown.

In the case where an opening having a size equal to or less than the wavelength of excitation light is provided for an opaque mask for excitation light, the excitation light is present as near-field light which leaks in the inside of a minute opening or in the immediate vicinity thereof. The excitation light is not transmitted as light propagating in the opposite direction, and therefore does not excite a fluorescent dye located at a distance from the opening. Accordingly, in the same manner as in the case of using an evanescent wave, the background light can be greatly reduced. The opening as used herein may be a physical hole or a window formed by an optically transparent member. Further, in the case where the opening has a size larger than the wavelength of excitation light, illumination is not achieved by near-field light, however, by suppressing the intensity of the excitation light transmitted through the substrate, the background light can also be reduced.

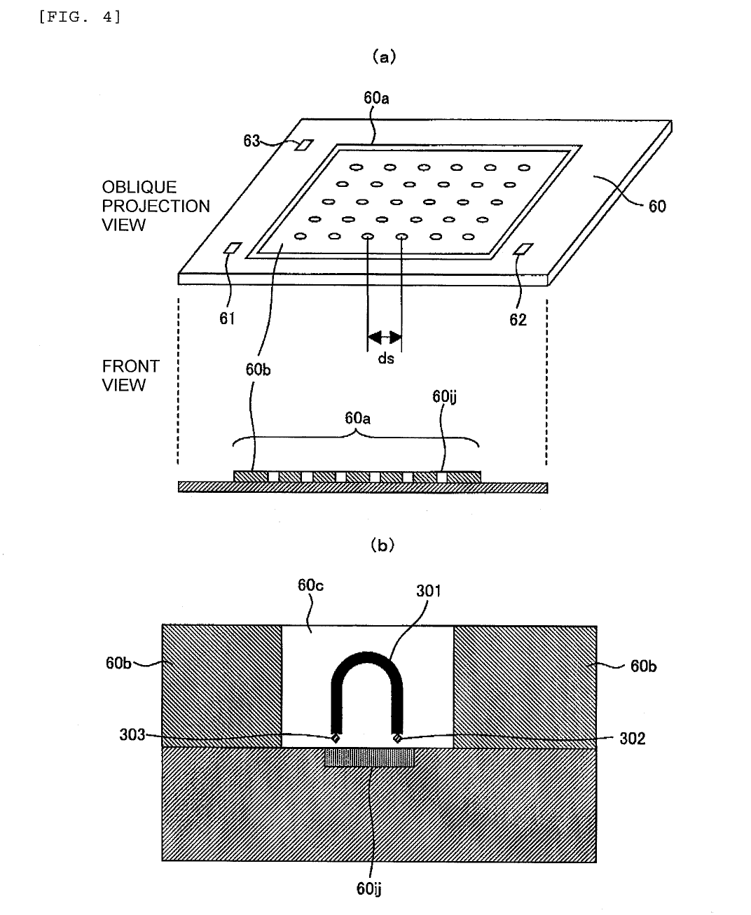

A structure of a substrate 60 according to this embodiment is shown in FIG. 4(a). The substrate 60 has a reaction region 60a, and a plurality of reaction regions 60ij for capturing a nucleic acid sample therein are formed at a pitch of ds in the reaction region 60a, and further has a structure in which a plurality of the reaction regions 60ij are each surrounded by an optically opaque mask 60b. That is, in an opening 60c provided in the mask 60b, the reaction region 60ij is present. As a material of the mask, a metal such as aluminum or chromium, silicon carbide, or the like can be used, and the material is formed into a thin film by vapor deposition or the like. The reaction regions 60ij each have a diameter of 100 nm or less. As for a method for forming such an opening in the mask 60b, the opening can be formed by vapor deposition using a projection method (the vapor deposition is performed by disposing an appropriate mask between a vapor deposition source and a substrate) or direct writing using electron beam lithography or photolithography. Dry etching or wet etching may also be used.

As a method for capturing the DNA fragment 301 on the reaction region 60ij, a method previously described can be used (FIG. 4(b)). In the case where the substrate 60 is made of synthetic quartz, aminosilane is allowed to react to introduce an amino group, and thereafter biotin-succinimide (NHS-biotin, manufactured by Pierce Chemical Company) is allowed to react, and then, streptavidin is allowed to react, whereby avidin modification as the modification 303 can be easily performed. Further, by immobilizing a nucleic acid molecule with a biotinylated end as the modification 302, it becomes possible to capture a nucleic acid sample at two or more points.

In this embodiment, by detecting Raman scattering light of a sample solution around the biological molecule and photoluminescence and light scattering of the metal structure in the vicinity of the biological molecule, the spatial position of the structure can be detected, and the structure can be utilized as a positional reference marker.

The metal structure may be formed in each opening. In the same manner as in Embodiment 1, also positioning markers 61, 62, and 63 can be disposed, whereby the same effect as in Embodiment 1 can be expected.

According to this embodiment, the same effect as in the above-described Embodiment 1 or the like can also be obtained. In addition, since regions other than the reaction regions 60ij are covered by a mask, unnecessary stray light and fluorescence can be reduced, and the measurement can be performed with higher sensitivity.

### Embodiment 3

An example of another combination of phosphors will be described.

This embodiment can also be applied to the measurement of fluorescence using excitation energy transfer (so-called FRET, Fluoresent Resonance Energy Transfer) caused by resonance. For example, Qdot 525 having a fluorescence wavelength of 525 nm or the like can be used as a donor, and four types of phosphors, Alexa Fluor 546, Alexa Fluor 594, Alexa Fluor 633, and Alexa Fluor 660 can be used as acceptors. These five types of phosphors can be identified and discriminated on the basis of the fluorescence intensity ratios thereof in the same manner as in the above-described embodiments. In the case of FRET, a nucleic acid sample is captured at each dot (such as the region 8ij) in the reaction region described in Embodiment 1 or the like, and then, a nucleic acid synthetase labeled with Qdot is supplied, and four types of bases with fluorescence are allowed to react therewith, respectively. The fluorescence intensities are detected and the respective detected fluorescence intensity ratios are computed by the apparatus described in the above-described embodiment, whereby the types of phosphors can be identified. The states of the respective regions include: a dot at which nothing is captured; a dot at which only Qdot is captured; a dot at which Qdot and Alexa Fluor 546 are captured; a dot at which Qdot and Alexa Fluor 594 are captured; a dot at which Qdot and Alexa Fluor 633 are captured; and a dot at which Qdot and Alexa Fluor 660 are captured. Fluorescence is detected from the dots at which Qdot is captured, but the fluorescence intensity ratio thereof is different, and the fluorescence intensity of Qdot is decreased by excitation energy transfer. Accordingly, the combination state can be identified on the basis of the fluorescence intensity ratio. Further, the unreacted base with fluorescence which is not incorporated in a nucleic acid chain by the nucleic acid synthetase does not emit fluorescence by FRET since the base is apart from Qdot. Therefore, it is also possible to fluorescently detect a manner in which four types of bases with fluorescence are incorporated in a nucleic acid chain in real time without performing a step of washing away the unreacted bases with fluorescence.

### Reference Signs List

5 Mirror

7 Prism

8, 60 Substrate

8a, 60a, 8ij, 60ij Reaction Region

9 Flow Chamber

10 Waste Liquid Tube

11 Waste Liquid Container

12 Inlet

13 Fluorescence

14 Condenser Lens (objective lens)

15, 406 Filter Unit

16 Lens Tube for Observation of Transmitted Light

17a, 17b Auxiliary Filter

18a, 18b Imaging Lens

19a, 19b CCD Camera

20a, 20b Two-dimensional Sensor Camera Controller

21 Control PC

22, 24 Monitor

23 TV Camera

25 Dispensing Unit

26 Dispensing Nozzle

27 Reagent Storage Unit

27a Sample Solution Container

27b, 27c, 27d, 27e dNTP Derivative Solution Container

27f Washing Liquid Container

28 Tip Box

29 Automatic Focusing Device

30, 31, 61, 62, 63 Positioning Marker

32, 103, 104a Dichroic Mirror

60b Mask

60c Opening

100, 101a, 101b Laser Light Source

102a, 102b λ/4 Wave Plate

dx, dy Dimension of Distance Between Regions 8ij

301 DNA Fragment

302, 303 Modification for Binding

304 Region

305 Microparticle

306 Adhesive Pad

1. A nucleic acid analysis device, in which a plurality of regions for immobilizing a nucleic acid sample are provided on a surface of a support base and a single molecule of a nucleic acid sample is immobilized on at least one of, the regions, and which performs sequence determination by performing an extension reaction of the immobilized nucleic acid sample, wherein the immobilization of the single molecule of the nucleic acid sample on the support base is performed at two or more points.

2. The nucleic acid analysis device according to claim 1, wherein the regions are subjected to a surface treatment so that the nucleic acid sample can be immobilized thereon.

3. The nucleic acid analysis device according to claim 2, wherein two or more different surface treatments are performed for at least one of the regions.

4. The nucleic acid analysis device according to claim 2, wherein the surface treatment varies between at least some of the regions.

5. The nucleic acid analysis device according to claim 1, wherein a metal structure is disposed in the regions.

6. The nucleic acid analysis device according to claim 5, wherein a microparticle is immobilized on the metal structure.

7. The nucleic acid analysis device according to claim 6, wherein the metal structure has a circular planar shape and has a diameter smaller than that of the microparticle.

8. The nucleic acid analysis device according to claim 5, wherein the metal structure is made of any of gold, silver, aluminum, chromium, titanium, tungsten, platinum, and nickel.

9. The nucleic acid analysis device according to claim 1, wherein the regions are arranged in a lattice pattern.

10. The nucleic acid analysis device according to claim 1, wherein at least one end of the nucleic acid sample is immobilized on the support base at the 3′ end.

11. The nucleic acid analysis device according to claim 2, wherein the surface treatment is a nucleic acid molecule immobilized on the surface of the support base.

12. A nucleic acid analysis method in which sequence determination is performed by immobilizing a single molecule of a nucleic acid sample in at least one of a plurality of regions for immobilizing a nucleic acid sample on a surface of a support base and performing an extension reaction of the immobilized nucleic acid sample, wherein the immobilization of the single molecule of the nucleic acid sample to the support base is performed at two or more points.

13. A nucleic acid analysis method comprising:
a step of performing a nucleic acid synthesis reaction by bringing a nucleic acid synthetase and bases with a fluorescent dye into contact with a nucleic acid sample; and
a step of detecting fluorescence generated by exciting a label by local illumination, wherein
the method includes:
a step of immobilizing a single molecule on a surface of a support base at a first point of a nucleic acid sample; and
a step of immobilizing the molecule on the surface of the support base at a second point of the nucleic acid sample.

14. The nucleic acid analysis method according to claim 13, wherein a step including the step of detecting fluorescence generated by excitation through local illumination is performed in a state where the bases with a fluorescent dye are present around the nucleic acid sample.

15. The nucleic acid analysis method according to claim 13, wherein a phosphor is bound to the nucleic acid synthetase.

16. The nucleic acid analysis method according to claim 13, wherein the immobilization of the nucleic acid sample on the support base is achieved through both ends of one strand of the nucleic acid sample.

17. The nucleic acid analysis method according to claim 13, wherein the immobilization of the nucleic acid sample on the support base is achieved through a covalent bond.

18. The nucleic acid analysis method according to claim 13, wherein the immobilization of the nucleic acid sample on the support base is achieved through a protein.

19. The nucleic acid analysis method according to claim 13, wherein the immobilization of the nucleic acid sample on the support base is performed at three or more points.

20. The nucleic acid analysis method according to claim 13, wherein the method includes a step of introducing a modification into both ends of the nucleic acid sample.

21. A nucleic acid analysis apparatus which determines a base sequence of a nucleic acid sample and comprises:
a nucleic acid analysis device in which a plurality of regions for immobilizing a nucleic acid sample are provided on a surface of a support base and a single molecule of a nucleic acid sample is immobilized on at least one of the regions;
a section which supplies at least a nucleic acid sample to the nucleic acid analysis device;
a section which irradiates the nucleic acid analysis device with light; and
a detection section which detects fluorescence incorporated by a nucleic acid extension reaction, wherein
the immobilization of the single molecule of the nucleic acid sample on the support base is performed at two or more points.

22. The nucleic acid analysis apparatus according to claim 21, wherein the regions are arranged in a lattice pattern.
